(19) United States
(12) Patent Application Publication
(10) Pub. No.: US 2026/0066345 A1
(43) Pub. Date: Mar. 5, 2026

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: KITAE KIM, Yongin-si (KR); Tae Jin LEE, Yongin-si (KR); Keunhyuk LEE, Yongin-si (KR)

(21) Appl. No.: 19/179,994

(22) Filed: Apr. 15, 2025

(30) Foreign Application Priority Data
Sep. 5, 2024 (KR) 10-2024-0120754

(51) Int. Cl. H01M 10/0567; H01M 4/02; H01M 4/131; H01M 4/133; H01M 4/134; H01M 4/38; H01M 4/485; H01M 4/587; H01M 10/0525; H01M 10/0568; H01M 10/0569

(52) U.S. Cl. CPC H01M 10/0567; H01M 4/131; H01M 4/133; H01M 4/134; H01M 4/386; H01M 4/485; H01M 4/587; H01M 10/0568; H01M 10/0569; H01M 2004/027; H01M 2004/028; H01M 10/0525

(57) ABSTRACT

An electrolyte for a rechargeable lithium battery and a rechargeable lithium battery including the electrolyte are disclosed. The electrolyte may include a non-aqueous (e.g., water-insoluble) organic solvent, a lithium salt, a first additive that includes a cesium salt compound represented by Chemical Formula 1-1 or Chemical Formula 1-2, and a second additive that includes a phosphazene compound represented by Chemical Formula 2.

### CROSS-REFERENCE TO RELATED APPLICATION

The present application claims priority to and the benefit of Korean Patent Application No. 10-2024-0120754, filed on Sep. 5, 2024, in the Korean Intellectual Property Office, the entire disclosure of which is incorporated herein by reference.

### BACKGROUND

### 1. Field

One or more embodiments of the present disclosure relate to an electrolyte for a rechargeable lithium battery and a rechargeable lithium battery including the electrolyte.

### 2. Description of the Related Art

Recently, with the rapid proliferation and spread of electronic devices that use batteries (such as mobile phones, laptop computers, and/or the like) and/or electric vehicles, the demand for rechargeable batteries with high energy density and high capacity (e.g., electrical capacity) is rapidly increasing. Therefore, intensive research and development have been conducted to improve or enhance performance of rechargeable lithium batteries.

A rechargeable lithium battery includes a positive electrode, a negative electrode, and an electrolyte. The positive electrode and the negative electrode include an active material in which intercalation and deintercalation may occur. The rechargeable lithium battery generates electrical energy through oxidation and reduction reactions if (e.g., when) lithium ions are intercalated and deintercalated.

A lithium salt dissolved in a non-aqueous (e.g., water-insoluble) organic solvent is used as the electrolyte of the rechargeable lithium battery. The characteristics of the rechargeable lithium battery are exhibited by complex electrochemical reactions between the positive electrode and the electrolyte and/or between the negative electrode and the electrolyte. Accordingly, the use of an appropriate or suitable electrolyte is one of important variables for the improvement or enhancement of the rechargeable lithium battery.

### SUMMARY

One or more aspects of embodiments of the present disclosure are directed toward an electrolyte for a rechargeable lithium battery with (or having) improved or enhanced stability (e.g., chemical stability and/or physical stability) and lifespan characteristics at relatively high temperatures.

One or more aspects of embodiments of the present disclosure are directed toward a rechargeable lithium battery including the electrolyte.

Additional aspects of embodiments will be set forth in part in the description which follows and, in part, will be apparent from the description or may be learned by practice of the presented embodiments of the disclosure.

According to one or more embodiments of the present disclosure, an electrolyte for a rechargeable lithium battery may include: a non-aqueous (e.g., water-insoluble) organic solvent; a lithium salt; a first additive that includes a cesium salt compound represented by Chemical Formula 1-1 or Chemical Formula 1-2; and a second additive that includes a phosphazene compound represented by Chemical Formula 2.

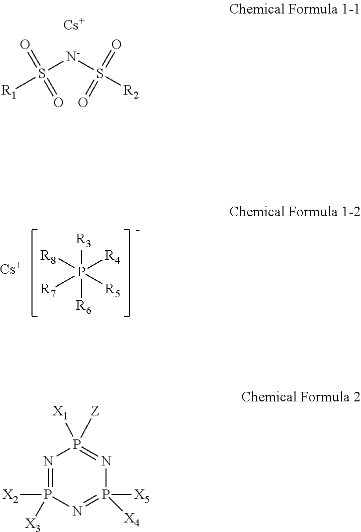

In Chemical Formula 1-1 or Chemical Formula 1-2,

R₁ to R₈ may each independently be a fluoro group or a C1 to C4 fluoroalkyl group substituted with at least one fluoro group.

In Chemical Formula 2,

X₁ to X₅ may each independently be a halogen atom (e.g., F, Cl, Br, or I) or a halogen-containing group.

Z may be —NR₉R₁₀ or —OR₁₁.

R₉ and R₁₀ may each independently be a substituted or unsubstituted C1 to C30 alkyl group or a substituted or unsubstituted C1 to C30 cycloalkyl group.

R₁₁ may be a substituted or unsubstituted C1 to C30 alkyl group.

According to one or more embodiments of the present disclosure, a rechargeable lithium battery may include: a positive electrode that includes a positive electrode active material; a negative electrode that includes a negative electrode active material; a first additive that includes a cesium salt compound represented by Chemical Formula 1-1 or Chemical Formula 1-2; and a second additive that includes a phosphazene compound represented by Chemical Formula 2.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a simplified conceptual diagram illustrating a rechargeable lithium battery according to one or more embodiments of the present disclosure.

FIGS. 2-5 are simplified diagrams each illustrating a rechargeable lithium battery according to one or more embodiments, with FIG. 2 illustrating a cylindrical battery, FIG. 3 illustrating a prismatic battery, and FIGS. 4 and 5 illustrating pouch-type (kind) batteries.

### DETAILED DESCRIPTION

In order to sufficiently understand the aspects and features of the present disclosure, the subject matter of the present disclosure will be described below in more detail with reference to the accompanying drawings. It should be noted, however, that the present disclosure is not limited to the disclosed embodiments and may be implemented in one or more suitable forms. Rather, these embodiments are provided as examples, by referring to the drawings, to explain the aspects and features of the present disclosure to those skilled in the art.

In the present disclosure, it will be understood that, if (e.g., when) an element is referred to as being “on” another element, the element may be directly on the other element or intervening elements may be present therebetween. In contrast, if (e.g., when) an element is referred to as being “directly on” another element, no intervening elements are present therebetween.

In the drawings, thicknesses of one or more components may be exaggerated to effectively illustrate the technical contents. Like reference numerals refer to like elements throughout, and duplicative descriptions thereof may not be provided in the present disclosure.

Unless otherwise noted in the present disclosure, the expression of singular form may include the expression of plural form. In addition, unless otherwise noted, the phrase “A or B” may indicate “A but not B”, “B but not A”, and “A and B”. The terms “includes/includes” and/or “including/including” used in the present disclosure do not exclude the presence or addition of one or more other components.

In the present disclosure, it will be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Additionally, the terms “comprise(s)/comprising,” “include(s)/including,” “have/has/having” or similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

In the present disclosure, the term “combination thereof” may refer to a mixture, a stack, a composite, a copolymer, an alloy, a blend, a reaction product, and/or the like of constituents.

In the present disclosure, unless otherwise separately defined, the term “substituted” may refer to that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, and/or a (e.g., any suitable) combination thereof.

In more detail, the term “substituted” may refer to that at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may refer to that at least one hydrogen of a substituent or a compound is substituted by deuterium, a halogen group, a C1 to C20 alkyl group, a C6 to C30 aryl group, a C1 to C10 fluoroalkyl group, or a cyano group. In one or more embodiments, the term “substituted” may refer to that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may refer to that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluoromethyl group, or a naphthyl group.

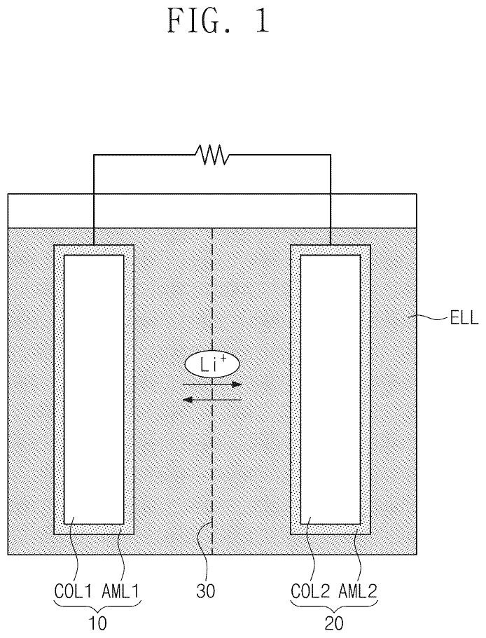

FIG. 1 is a simplified conceptual diagram illustrating a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in (or with) the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material and may further include a binder and/or a conductive (e.g., electrically conductive) material (e.g., an electron conductor).

For example, the positive electrode 10 may further include an additive that may act or serve as a sacrificial positive electrode.

An amount of the positive electrode active material may be about 90 wt % to about 99.5 wt % relative to 100 wt % (e.g., based on 100 wt % of a total amount) of the positive electrode active material layer AML1. An amount of each of the binder and the conductive (e.g., electrically conductive) material (e.g., an electron conductor) may be about 0.5 wt % to about 5 wt % relative to 100 wt % (e.g., based on 100 wt % of a total amount) of the positive electrode active material layer AML1.

The binder may act or serve to improve or enhance attachment of positive electrode active material particles to each other and also to improve or enhance attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and/or nylon, but embodiments of the present disclosure are not limited thereto.

The conductive (e.g., electrically conductive) material (e.g., an electron conductor) may be used to provide an electrode with conductivity (e.g., electrical conductivity), and any suitable conductive (e.g., electrically conductive) material that does not cause a chemical change (e.g., an undesirable chemical change) in a rechargeable lithium battery may be used as the conductive (e.g., electrically conductive) material. The conductive (e.g., electrically conductive) material (e.g., an electron conductor) may include, for example, a carbon-based material, such as natural graphite, artificial graphite, carbon black, acetylene black, Ketjen black, carbon fiber, carbon nano-fiber, and carbon nano-tube; a metal powder and/or a metal fiber containing one or more selected from among copper, nickel, aluminum, and silver; a conductive (e.g., electrically conductive) polymer, such as polyphenylene and a polyphenylene derivative; and/or a (e.g., any suitable) mixture thereof.

Aluminum (Al) may be used as the current collector COL1, but embodiments of the present disclosure are not limited thereto.

### Positive Electrode Active Material

The positive electrode active material in the positive electrode active material layer AML1 may include a compound (e.g., a lithiated intercalation compound) that may reversibly intercalate and deintercalate lithium. For example, the positive electrode active material may include at least one kind or type of a composite oxide including lithium and metal that is selected from among cobalt, manganese, nickel, and/or a (e.g., any suitable) combination thereof.

The composite oxide may include a lithium transition metal composite oxide, for example, a lithium-nickel-based oxide, a lithium-cobalt-based oxide, a lithium-manganese-based oxide, lithium-iron-phosphate-based compounds, a cobalt-free nickel-manganese-based oxide, and/or a (e.g., any suitable) combination thereof.

For example, the positive electrode active material may include a compound expressed by one selected from among chemical formulae: LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}CO_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}CO_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); and LiₐFePO₄ (where 0.90≤a≤1.8).

In the foregoing chemical formulae, A may be nickel (Ni), cobalt (Co), manganese (Mn), and/or a (e.g., any suitable) combination thereof, X may be aluminum (Al), Ni, Co, Mn, chromium (Cr), iron (Fe), magnesium (Mg), strontium (Sr), vanadium (V), a rare-earth element, and/or a (e.g., any suitable) combination thereof, D may be oxygen (O), fluorine (F), sulfur(S), phosphorus (P), and/or a (e.g., any suitable) combination thereof, G may be Al, Cr, Mn, Fe, Mg, lanthanum (La), cerium (Ce), Sr, V, and/or a (e.g., any suitable) combination thereof, and L¹ may be Mn, Al, and/or a (e.g., any suitable) combination thereof.

For example, the positive electrode active material may be a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % (e.g., based on 100 mol % of a total amount) of metal devoid of lithium in the lithium transition metal composite oxide. The high-nickel-based positive electrode active material may achieve or provide relatively high capacity (e.g., electrical capacity) and thus may be applied to a high-capacity (e.g., high electrical capacity) and high-density (e.g., high energy density) rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material and may further include a binder and/or a conductive (e.g., electrically conductive) material (e.g., an electron conductor).

For example, the negative electrode active material layer AML2 may include a negative electrode active material of about 90 wt % to about 99 wt %, a binder of about 0.5 wt % to about 5 wt %, and a conductive (e.g., electrically conductive) material of about 0 wt % to about 5 wt %.

The binder may act or serve to improve or enhance attachment of negative electrode active material particles to each other and also to improve or enhance attachment of the negative electrode active material to the current collector COL2. The binder may include a non-aqueous (e.g., water-insoluble) binder, an aqueous (e.g., water-soluble) binder, a dry binder, and/or a (e.g., any suitable) combination thereof.

The non-aqueous (e.g., water-insoluble) binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous (e.g., water-soluble) binder may include a styrene-butadiene rubber, a (meth)acrylated styrene-butadiene rubber, a (meth)acrylonitrile-butadiene rubber, a (meth)acrylic rubber, a butyl rubber, a fluoro elastomer, a polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenolic resin, an epoxy resin, polyvinyl alcohol, and/or a (e.g., any suitable) combination thereof.

If (e.g., when) an aqueous (e.g., water-soluble) binder is used as the negative electrode binder, a cellulose-based compound capable of providing or increasing viscosity may further be included. The cellulose-based compound may include one or more selected from among carboxymethyl cellulose, hydroxypropyl methylcellulose, methyl cellulose, and alkali metal salts thereof. The alkali metal may include sodium (Na), potassium (K), and/or lithium (Li).

The dry binder may include a fibrillizable polymer material, for example, polytetrafluoroethylene, polyvinylidene fluoride, a polyvinylidene fluoride-hexafluoropropylene copolymer, polyethylene oxide, and/or a (e.g., any suitable) combination thereof.

The conductive (e.g., electrically conductive) material (e.g., an electron conductor) may be used to provide an electrode with conductivity (e.g., electrical conductivity), and any suitable conductive (e.g., electrically conductive) material that does not cause a chemical change (e.g., an undesirable chemical change) in a rechargeable lithium battery may be used as the conductive (e.g., electrically conductive) material. For example, the conductive (e.g., electrically conductive) material (e.g., an electron conductor) may include a carbon-based material, such as natural graphite, artificial graphite, carbon black, acetylene black, Ketjen black, carbon fiber, carbon nano-fiber, and carbon nano-tube; a metal powder and/or a metal fiber including one or more selected from among copper, nickel, aluminum, and silver; a conductive (e.g., electrically conductive) polymer, such as polyphenylene and a polyphenylene derivative; and/or a (e.g., any suitable) mixture thereof.

The current collector COL2 may include a copper foil, a nickel foil, a stainless-steel foil, a titanium foil, a nickel foam, a copper foam, a polymer substrate coated with a conductive (e.g., electrically conductive) metal, and/or a (e.g., any suitable) combination thereof.

### Negative Electrode Active Material

The negative electrode active material in the negative electrode active material layer AML2 may include a material that may reversibly intercalate and deintercalate lithium ions, lithium metal, a lithium metal alloy, a material that may dope and de-dope lithium, and/or transition metal oxide.

The material that may reversibly intercalate and deintercalate lithium ions may include a carbon-based negative electrode active material, for example, crystalline carbon, amorphous (e.g., non-crystalline) carbon, and/or a (e.g., any suitable) combination thereof. For example, the crystalline carbon may include graphite, such as non-shaped (e.g., substantially non-shaped), sheet-shaped (e.g., substantially sheet-shaped), flake-shaped (e.g., substantially flake-shaped), sphere-shaped (e.g., substantially sphere-shaped), or fiber-shaped (e.g., substantially fiber-shaped) natural graphite and/or artificial graphite, and the amorphous (e.g., non-crystalline) carbon may include soft carbon, hard carbon, mesophase pitch carbon, and/or calcined coke.

The lithium metal alloy may include an alloy of lithium and metal that is selected from among Na, K, rubidium (Rb), cesium (Cs), francium (Fr), beryllium (Be), Mg, calcium (Ca), Sr, silicon (Si), antimony (Sb), lead (Pb), indium (In), zinc (Zn), barium (Ba), radium (Ra), germanium (Ge), Al, and tin (Sn).

The material that may dope and de-dope lithium may include a Si-based negative electrode active material and/or a Sn-based negative electrode active material. The Si-based negative electrode active material may include silicon, silicon-carbon composite, SiOₓ (where 0<x≤2; SiO₂), Si-Q alloy (where Q may be alkali metal, alkaline earth metal, Group 13 element, Group 14 element (except for Si), Group 15 element, Group 16 element, transition metal, a rare-earth element, and/or a (e.g., any suitable) combination thereof), and/or a (e.g., any suitable) combination thereof. The Sn-based negative electrode active material may include Sn, SnOₓ (where 0<x≤2; SnO₂), a Sn-based alloy, a (e.g., any suitable) combination thereof.

The silicon-carbon composite may be a composite of silicon and amorphous (e.g., non-crystalline) carbon. According to one or more embodiments, the silicon-carbon composite may have a structure in which the amorphous (e.g., non-crystalline) carbon is coated on a surface of the silicon particle. For example, the silicon-carbon composite may include a secondary particle (core) in which primary silicon particles are assembled, and an amorphous (e.g., non-crystalline) carbon coating layer (shell) on a surface of the secondary particle. The amorphous (e.g., non-crystalline) carbon may also be between the primary silicon particles, and for example, the primary silicon particles may be coated with the amorphous (e.g., non-crystalline) carbon. The secondary particles may be present dispersed in an amorphous (e.g., non-crystalline) carbon matrix.

The silicon-carbon composite may further include crystalline carbon. For example, the silicon-carbon composite may include a core including crystalline carbon and silicon particles and may also include an amorphous (e.g., non-crystalline) carbon coating layer on a surface of the core.

The Si-based negative electrode active material and/or the Sn-based negative electrode active material may be used in combination with a carbon-based negative electrode active material.

### Separator 30

Based on a type (or kind) of the rechargeable lithium battery, the separator 30 may be between the positive electrode 10 and the negative electrode 20. The separator 30 may include one or more selected from among polyethylene, polypropylene, and polyvinylidene fluoride and may have a multi-layered separator thereof, such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer on one surface or both surfaces (e.g., two opposite (opposite facing) surfaces) of the porous substrate, which the coating layer may include an organic material, an inorganic material, and/or a (e.g., any suitable) combination thereof.

The porous substrate may be a polymer layer including one selected from among polyolefin, such as polyethylene and polypropylene, polyester, such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, a cyclic olefin copolymer, polyphenylenesulphide, polyethylene naphthalate, glass fiber, and polytetrafluoroethylene (e.g., Teflon™), or may be a copolymer or (e.g., any suitable) mixture including two or more of the materials as described in one or more embodiments.

The organic material may include a polyvinylidenefluoride-based copolymer and/or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, and/or a (e.g., any suitable) combination thereof, but embodiments of the present disclosure are not limited thereto.

The organic material and the inorganic material may be present mixed in one coating layer or may be present as a stack of a coating layer including the organic material and a coating layer including an inorganic material.

### Electrolyte ELL

The electrolyte ELL for a rechargeable lithium battery may include a non-aqueous (e.g., water-insoluble) organic solvent and a lithium salt.

The non-aqueous (e.g., water-insoluble) organic solvent may act or serve as a medium to transmit ions that participate in an electrochemical reaction of the rechargeable lithium battery.

The non-aqueous (e.g., water-insoluble) organic solvent may include a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, and/or caprolactone.

The ether-based solvent may include dibutyl ether, tetraglyme, diglyme, dimethoxyethane, 2-methyltetrahydrofuran, 2,5-dimethyltetrahydrofuran, and/or tetrahydrofuran. The ketone-based solvent may include cyclohexanone. The alcohol-based solvent may include ethyl alcohol and/or isopropyl alcohol, and the aprotic solvent may include nitriles, such as R-CN (where R may be a hydrocarbon group having a C2 to C20 linear, branched, or cyclic structure and may include a double bond, an aromatic ring, and/or an ether group); amides, such as dimethylformamide; dioxolanes, such as 1,3-dioxolane or 1.4-dioxolane; and/or sulfolanes.

The non-aqueous (e.g., water-insoluble) organic solvent may be used alone or in a mixture of two or more substances.

In one or more embodiments, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be a material that is dissolved in the non-aqueous (e.g., water-insoluble) organic solvent to act or serve as a supply source of lithium ions in a rechargeable lithium battery and plays a role in enabling a basic operation of a rechargeable lithium battery and in promoting the movement of lithium ions between the positive electrode and the negative electrode. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y may be integers of 1 to 20), lithium trifluoromethane sulfonate, lithium tetrafluoroethanesulfonate, lithium difluoro (oxalato) borate (LiDFOB), lithium difluorobis(oxalato)phosphate (LiDFOP), and lithium bis(oxalato) borate (LiBOB).

### Rechargeable Lithium Battery

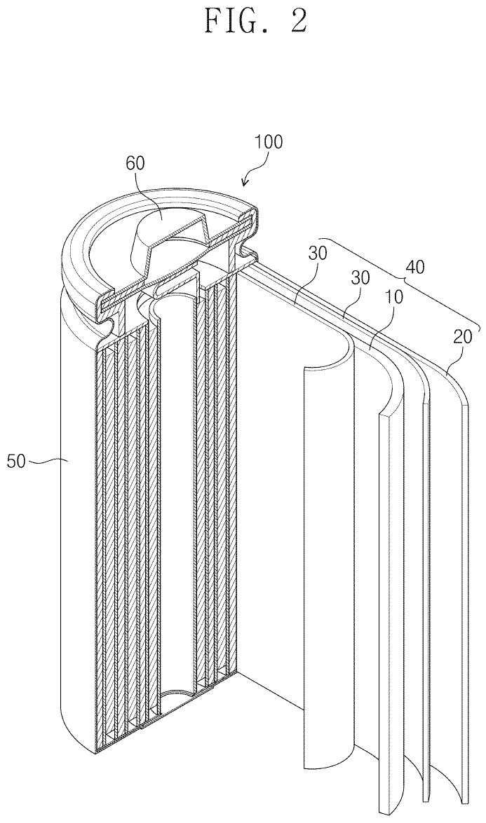

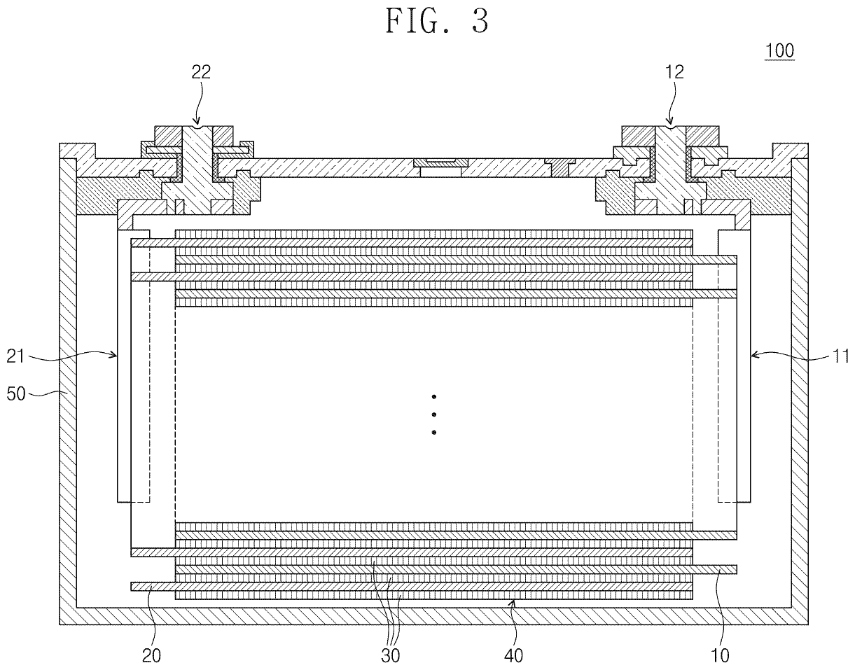

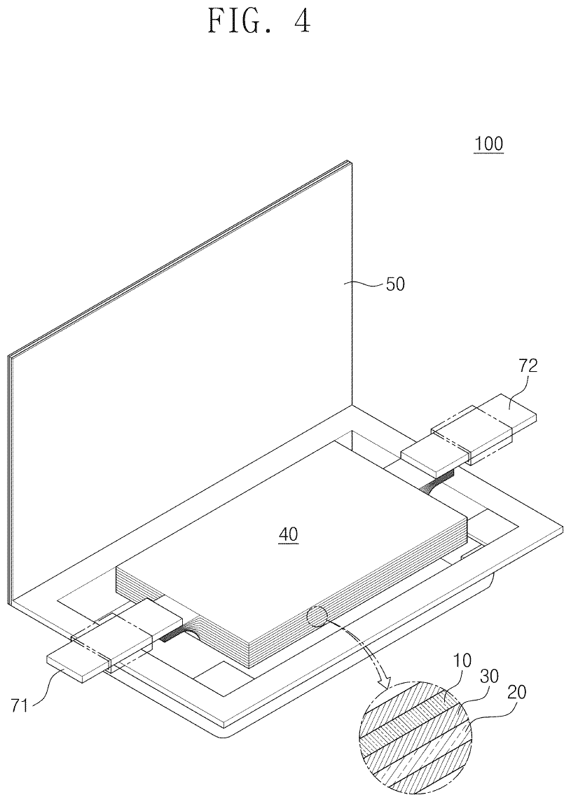

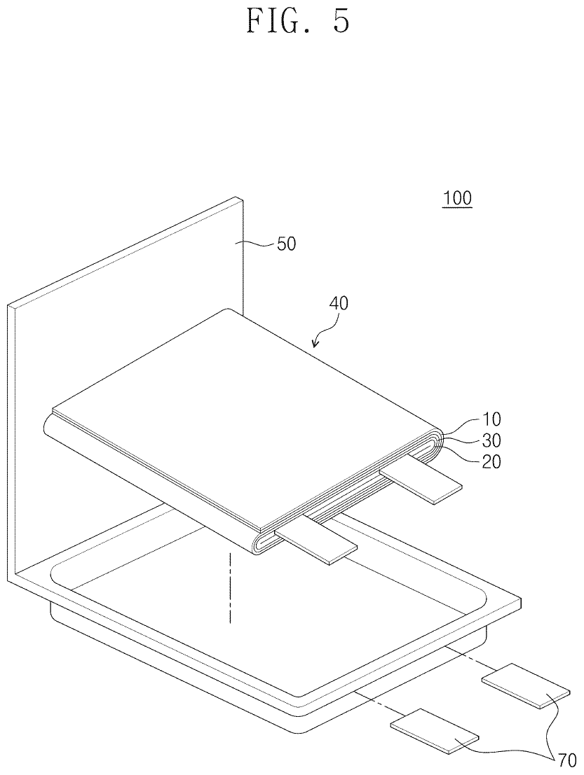

Based on a shape of a rechargeable lithium battery, the rechargeable lithium battery may be classified into cylindrical, prismatic, pouch, and coin types (or kinds). In FIGS. 2 to 5 illustrating simplified diagrams each depicting a rechargeable lithium battery according to one or more embodiments, FIG. 2 illustrates a cylindrical battery, FIG. 3 illustrates a prismatic battery, and FIGS. 4 and 5 illustrate pouch-type (or kind) batteries. Referring to FIGS. 2 to 4, a rechargeable lithium battery 100 may include an electrode assembly 40 in which a separator 30 is between a positive electrode 10 and a negative electrode 20 and may also include a casing 50 in which the electrode assembly 40 is accommodated or provided. The positive electrode 10, the negative electrode 20, and the separator 30 may be impregnated in (or with) an electrolyte. The rechargeable lithium battery 100 may include a sealing member 60 that seals the casing 50 as illustrated in FIG. 2. In one or more embodiments, as illustrated in FIG. 3, the rechargeable lithium battery 100 may include a positive electrode lead tab 11, a positive electrode terminal 12, a negative electrode lead tab 21, and a negative electrode terminal 22. As illustrated in FIGS. 4 and 5, the rechargeable lithium battery 100 may include an electrode tab 70, or a positive electrode tab 71 and a negative electrode tab 72, which electrode tab 70 may act or serve as an electrical path to externally induce a current generated in the electrode assembly 40.

The following will describe in more detail an electrolyte for a rechargeable lithium battery according to one or more embodiments of the present disclosure.

An electrolyte for a rechargeable lithium battery according to one or more embodiments may include a non-aqueous (e.g., water-insoluble) organic solvent, a lithium salt, a first additive represented by Chemical Formula 1-1 or Chemical Formula 1-2, and a second additive represented by Chemical Formula 2.

The electrolyte may be prepared by a mixing process in which the lithium salt is dissolved in the non-aqueous (e.g., water-insoluble) organic solvent. The first additive and the second additive are added (e.g., concurrently or sequentially) to the mixture. The electrolyte mixing process may be generally available or generally used in electrolyte fabrication field, and a person skilled in the art will be able to appropriately or suitably select and use.

The non-aqueous (e.g., water-insoluble) organic solvent may include at least one selected from among ethylene carbonate (EC), ethyl methyl carbonate (EMC), dimethyl carbonate (DMC), propylene carbonate (PC), propyl propionate (PP), diethyl carbonate (DEC), dipropyl carbonate (DPC), methylpropyl carbonate (MPC), ethylpropyl carbonate (EPC), methylethyl carbonate (MEC), and butylene carbonate (BC).

In one or more embodiments, the non-aqueous (e.g., water-insoluble) organic solvent may be a mixed solvent of ethylene carbonate (EC), ethyl methyl carbonate (EMC), and dimethyl carbonate (DMC).

For example, the ethylene carbonate (EC) may be in an amount of about 10 vol % to about 40 vol % relative to the total volume (e.g., based on 100 vol % of a total amount) of the non-aqueous (e.g., water-insoluble) organic solvent. The ethyl methyl carbonate (EMC) may be in an amount of about 20 vol % to about 70 vol % relative to the total volume (e.g., based on 100 vol % of a total amount) of the non-aqueous (e.g., water-insoluble) organic solvent. The dimethyl carbonate (DMC) may be in an amount of about 20 vol % to about 70 vol % relative to the total volume (e.g., based on 100 vol % of a total amount) of the non-aqueous (e.g., water-insoluble) organic solvent.

The lithium salt may include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), and LiC₄F₉SO₃. The lithium salt may further include at least one selected from among lithium tetrafluoro(oxalato)phosphate (LITFOP), lithium difluoro bis(oxalato)phosphate (LiDFOP), lithium difluoro oxalato borate (LiDFOB), and lithium bis(oxalato) borate (LiBOB).

According to one or more embodiments, the lithium salt may include LiPF₆.

The lithium salt may have a concentration of about 0.1 M to about 2.0 M. For example, the lithium salt may have a concentration of equal to or greater than about 0.5 M or equal to or greater than about 1.0 M. The lithium salt may have a concentration of equal to or less than about 2.0 M, equal to or less than about 1.7 M, or equal to or less than about 1.5 M. In the present disclosure, if (e.g., when) the lithium salt has a concentration of about 0.1 M to about 2.0 M, the electrolyte may appropriately or suitably maintain or provide its conductivity (e.g., electrical conductivity) and viscosity.

### First Additive

The first additive according to one or more embodiments of the present disclosure may include a cesium salt compound. An anion of the cesium salt compound may be an imide-based anion or a phosphate-based anion.

The first additive may be represented by Chemical Formula 1-1 or Chemical Formula 1-2.

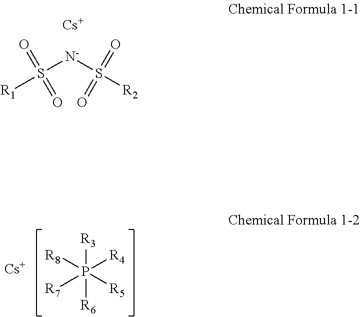

In Chemical Formula 1-1 or Chemical Formula 1-2, R₁ to R₈ may each independently be a fluoro group or a C1 to C4 fluoroalkyl group substituted with at least one fluoro group.

For example, in Chemical Formula 1-1 or Chemical Formula 1-2, R₁ to R₈ may each independently be a fluoro group or a C1 to C4 fluoroalkyl group substituted with at least two fluoro groups. For another example, in Chemical Formula 1-1 or Chemical Formula 1-2, R₁ to R₈ may each independently be a fluoro group or a C1 to C4 fluoroalkyl group substituted with at least three fluoro groups.

According to one or more embodiments, Chemical Formula 1-1 may be represented by Chemical Formula 1-1-A or Chemical Formula 1-1-B.

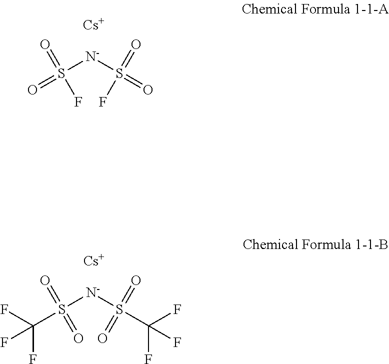

According to one or more embodiments, Chemical Formula 1-2 may be represented by Chemical Formula 1-2-A.

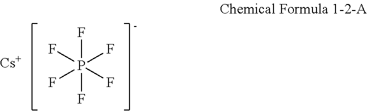

The first additive may be decomposed in the electrolyte to form a film on each of surfaces of the positive electrode and the negative electrode and may effectively or suitably control release of lithium ions from the positive electrode, thereby preventing positive electrode decomposition (or reducing a degree or occurrence of positive electrode decomposition). For example, the first additive may be reduced and decomposed earlier than a carbonate-based solvent in the non-aqueous (e.g., water-insoluble) organic solvent to form a solid electrolyte interface (SEI) film on the negative electrode and may prevent electrolyte decomposition and its resulting electrode decomposition (or may reduce a degree or occurrence of electrolyte decomposition and its resulting electrode decomposition), thereby suppressing an internal resistance increase caused by gas generation (or reducing a degree or occurrence of an internal resistance increase caused by gas generation). In other words, the first additive may decompose in the electrolyte to form a film on the surfaces of both (e.g., simultaneously) the positive electrode and the negative electrode, effectively or suitably controlling the release of lithium ions from the positive electrode and reducing its decomposition. For example, the first additive may decompose earlier than a carbonate-based solvent in the non-aqueous (e.g., water-insoluble) organic solvent, forming a solid electrolyte interface (SEI) film on the negative electrode. This helps prevent or reduce electrolyte and electrode decomposition, thereby reducing internal resistance increases caused by gas generation.

The first additive may be in an amount of about 0.01 wt % to about 5 wt % relative to the total weight (e.g., based on 100 wt % of a total amount) of the electrolyte. For example, the first additive may be in an amount of equal to or greater than about 0.1 wt % relative to the total weight (e.g., based on 100 wt % of a total amount) of the electrolyte. The first additive may be in an amount of equal to or less than about 4 wt %, equal to or less than about 3 wt %, or equal to or less than about 2 wt % relative to the total weight (e.g., based on 100 wt % of a total amount) of the electrolyte. In one or more embodiments, the first additive may be in an amount of about 0.1 wt % to about 1.0 wt % relative to the total weight (e.g., based on 100 wt % of a total amount) of the electrolyte. If (e.g., when) the amount of the first additive falls within the foregoing ranges, it may maximize or increase suppression of resistance increase (or may maximize or increase reduction of a degree or occurrence of resistance increase) at relatively high temperatures.

### Second Additive

A second additive according to one or more embodiments of the present disclosure may include a phosphazene compound. For example, the second additive may be represented by Chemical Formula 2.

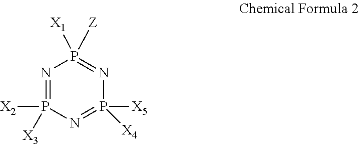

In Chemical Formula 2, X₁ to X₅ may each independently be a halogen atom (e.g., F, Cl, Br, or I) or a halogen-containing group, and Z may be —NR₉R₁₀ or —OR₁₁. In one or more embodiments, R₉ and R₁₀ may each independently be a substituted or unsubstituted C1 to C30 alkyl group or a substituted or unsubstituted C1 to C30 cycloalkyl group, and R₁₁ may be a substituted or unsubstituted C1 to C30 alkyl group.

For example, in Chemical Formula 2, at least one selected from among X₁ to X₅ may be a halogen atom (e.g., F, Cl, Br, or I). For another example, in Chemical Formula 2, X₁ to X₅ may each be a halogen atom (e.g., F, Cl, Br, or I). For another example, in Chemical Formula 2, X₁ to X₅ may each be fluorine.

If (e.g., when) Z is an alkoxy group, such as —OR₁₁ in Chemical Formula 2, the electrolyte may have a relatively high flash point and good or suitable self-extinguishing properties, thereby exhibiting or providing excellent or suitable flame retardancy. For example, if (e.g., when) Z is an alkoxy group, such as —OR₁₁ in Chemical Formula 2, R₁₁ may be a substituted or unsubstituted C1 to C5 alkyl group.

According to one or more embodiments, the second additive may include at least one selected from among compounds represented by Chemical Formula 2-1, Chemical Formula 2-2, and Chemical Formula 2-3.

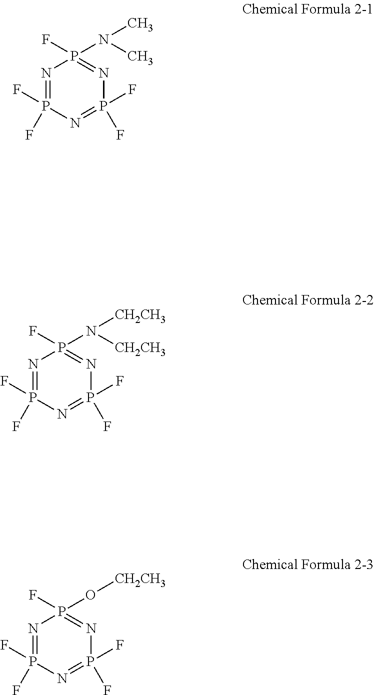 [SMILES: CN(C)P1(F)=NP(F)(F)=NP(F)(F)=N1 ; CCN(CC)P1(F)=NP(F)(F)=NP(F)(F)=N1 ; CCOP1(F)=NP(F)(F)=NP(F)(F)=N1]

The second additive according to one or more embodiments of the present disclosure may be a phosphazene compound with (or having) excellent or suitable flame retardancy and may prevent combustion (or may reduce a degree or occurrence of combustion) by capturing (or absorbing) oxygen (e.g., oxygen (O₂) gas) generated if (e.g., when) an electrolyte and/or an oxide-based positive electrode active material is decomposed during ignition. In one or more embodiments, the second additive may act or serve as a film decomposition additive to form a film whose resistance is relatively low. In one or more embodiments, a rechargeable lithium battery as described in one or more embodiments may have excellent or suitable performance at relatively high temperatures. In other words, the second additive, according to one or more embodiments of the present disclosure, may be a phosphazene compound with (or having) excellent or suitable flame retardancy. It may prevent or reduce combustion by capturing (or absorbing) oxygen (e.g., oxygen (O₂) gas) generated if (e.g., when) an electrolyte and/or an oxide-based positive electrode active material decomposes during ignition. In one or more embodiments, the second additive may act or serve as a film decomposition additive to form a film with relatively low resistance. The second additive may be in an amount of about 0.01 wt % to about 30 wt % relative to the total weight (e.g., based on 100 wt % of a total amount) of the electrolyte. For example, the second additive may be in an amount of equal to or greater than about 0.1 wt % or equal to or greater than about 0.5 wt % relative to the total weight (e.g., based on 100 wt % of a total amount) of the electrolyte. The second additive may be in an amount of equal to or less than about 15 wt % or equal to or less than about 2 wt % relative to the total weight (e.g., based on 100 wt % of a total amount) of the electrolyte. In one or more embodiments, the second additive may be in an amount of about 0.5 wt % to about 10 wt % relative to the total weight (e.g., based on 100 wt % of a total amount) of the electrolyte. If (e.g., when) the amount of the second additive falls within the foregoing ranges, the electrolyte may have an increased or higher flash point and exhibit or provide excellent or suitable flame retardancy, and a rechargeable lithium battery may have improved or enhanced stability (e.g., chemical stability and/or physical stability) without substantial reduction in rechargeable lithium battery performance, such as lifespan characteristics.

If (e.g., when) the second additive is used in combination with the first additive, a synergy effect may occur. For example, a more rigid film may be formed on the surfaces of the positive electrode and/or the negative electrode if (e.g., when) the first additive and the second additive are used in combination than if (e.g., when) each of the first additive and the second additive is used alone. In one or more embodiments, a rechargeable lithium battery as described in one or more embodiments may improve or enhance in stability (e.g., chemical stability and/or physical stability) at a relatively high-temperature environment. For example, if (e.g., when) the second additive is used in combination with the first additive, a synergy effect may occur. A more rigid film may be formed on the surfaces of the positive electrode and/or the negative electrode compared to if (e.g., when) each additive is used alone. According to one or more embodiments, an amount ratio of the first additive and the second additive may range from about 1:1 to about 1:100. For example, an amount ratio of the first additive and the second additive may range from about 1:1 to about 1:10.

If (e.g., when) the amount ratio of the first additive and the second additive is less than the foregoing ranges, there may be a slight effect of stability (e.g., chemical stability and/or physical stability) at high temperatures, and if (e.g., when) the amount ratio of the first additive and the second additive is greater than the foregoing ranges, there may be an abrupt or rapid reduction in lifespan efficiency of a rechargeable lithium battery.

In one or more embodiments of the present disclosure, a rechargeable lithium battery may include a positive electrode that includes a positive electrode active material, a negative electrode that includes a negative electrode active material, and an electrolyte, which the electrolyte may include a non-aqueous (e.g., water-insoluble) organic solvent, a lithium salt, a first additive represented by Chemical Formula 1-1 or Chemical Formula 1-2, and a second additive represented by Chemical Formula 2.

The rechargeable lithium battery according to one or more embodiments of the present disclosure may be applied to automotive vehicles, mobile phones, and/or any other electrical devices, but embodiments of the present disclosure are not limited thereto.

The positive electrode active material may include lithium composite oxide represented by Chemical Formula 3.

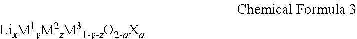

In Chemical Formula 3,

a, x, y, and z may satisfy the relationship of 0.5≤x≤1.8, 0≤a≤0.05, 0<y≤1, 0≤z≤1, and 0≤y+z≤1.

M¹, M², and M³ may each independently include at least one element selected from among metals of (e.g., such as) Ni, Co, Mn, Al, boron (B), Ba, Ca, Ce, Cr, Fe, molybdenum (Mo), niobium (Nb), Si, Sr, Mg, titanium (Ti), V, tungsten (W), zirconium (Zr), La, and/or a (e.g., any suitable) combination thereof.

X may include at least one element selected from among F, S, P, and Cl.

In one or more embodiments, in Chemical Formula 3, M¹ may be Ni, y may be 0.8≤y≤1, and z may be 0≤z≤0.2.

The negative electrode active material may include at least one selected from among graphite and a silicon composite.

If (e.g., when) the negative electrode active material includes both (e.g., simultaneously) a silicon composite and graphite, the silicon composite and the graphite may be in the form of a mixture, and, in one or more embodiments, the silicon composite and the graphite may be in a weight ratio of about 1:99 to about 50:50. For example, the silicon composite and the graphite may be in a weight ratio of about 3:97 to about 20:80 or about 5:95 to about 20:80.

The silicon composite may include a core including silicon-based particles and an amorphous (e.g., non-crystalline) carbon coating layer, and the silicon-based particle may include at least one selected from among a silicon-carbon composite, SiOₓ (where 0<x≤2), and a silicon alloy. For example, the silicon-carbon composite may include a core including silicon particles and crystalline carbon, and may also include an amorphous (e.g., non-crystalline) carbon coating layer on a surface of the core.

The crystalline carbon may include graphite, for example, natural graphite, artificial graphite, and/or a (e.g., any suitable) mixture thereof.

Hereinafter, embodiments of the present disclosure will be described in more detail with reference to Embodiments and Comparatives. However, the following examples are only examples of the present disclosure, and embodiments of the present disclosure are not limited to the following examples.

### Embodiments and Comparatives

### (1) Preparation of Electrolyte

1.15 M of LiPF₆ was dissolved in a non-aqueous (e.g., water-insoluble) organic solvent containing ethylene carbonate (EC), ethyl methyl carbonate (EMC), and dimethyl carbonate (DMC) mixed in a volume ratio of about 20:40:40, and a first additive and a second additive were added to prepare an electrolyte.

A substance represented by Chemical Formula 1-1-A, 1-1-B, or 1-2-A was used as the first additive.

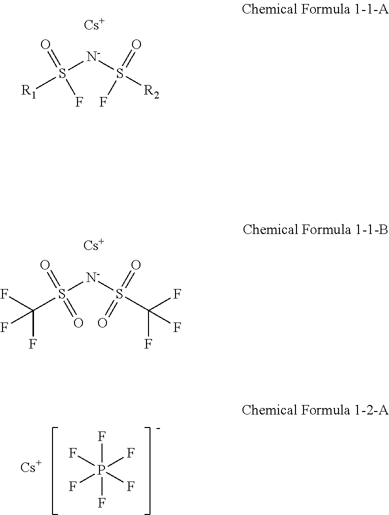

A substance represented by Chemical Formula 2-1 or Chemical Formula 2-3 was used as the second additive.

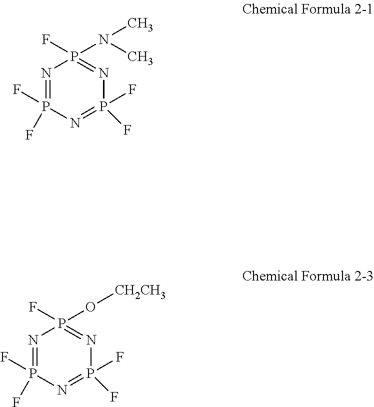

For example, the electrolytes according to Embodiments 1 to 18 and Comparatives 1 to 6 were prepared by using the compositions as illustrated in Table 1.

TABLE 1

| | | Non-aqueous | | | | | | | Mixing |
|---|---|---|---|---|---|---|---|---|---|
| | | (e.g., water- | | | | | | | ratio of |
| | Lithium | insoluble) | | | First | | Second | | additives |
| | salt | organic solvent | | | additive | | additive | | First |
| | (M) | (volume ratio) | | | | Amount | | Amount | additive:Second |
| | LiPF₆ | EC | EMC | DMC | Sort | (wt %) | Sort | (wt %) | additive |
| Compar- | 1.15 | 20 | 40 | 40 | — | — | — | — | — |
| ative 1 | | | | | | | | | |
| Compar- | 1.15 | 20 | 40 | 40 | Chemical | 0.5 | — | — | — |
| ative 2 | | | | | Formula | | | | |
| | | | | | 1-1-B | | | | |
| Compar- | 1.15 | 20 | 40 | 40 | Chemical | 0.5 | — | — | — |
| ative 3 | | | | | Formula | | | | |
| | | | | | 1-1-A | | | | |
| Compar- | 1.15 | 20 | 40 | 40 | Chemical | 0.5 | — | — | — |
| ative 4 | | | | | Formula | | | | |
| | | | | | 1-2-A | | | | |
| Compar- | 1.15 | 20 | 40 | 40 | — | — | Chemical | 2.0 | — |
| ative 5 | | | | | | | Formula | | |
| | | | | | | | 2-1 | | |
| Compar- | 1.15 | 20 | 40 | 40 | — | — | Chemical | 2.0 | — |
| ative 6 | | | | | | | Formula | | |
| | | | | | | | 2-3 | | |
| Embodi- | 1.15 | 20 | 40 | 40 | Chemical | 0.5 | Chemical | 2.0 | 1:4 |
| ment 1 | | | | | Formula | | Formula | | |
| | | | | | 1-1-B | | 2-1 | | |
| Embodi- | 1.15 | 20 | 40 | 40 | Chemical | 0.5 | Chemical | 2.0 | 1:4 |
| ment 2 | | | | | Formula | | Formula | | |
| | | | | | 1-1-B | | 2-3 | | |
| Embodi- | 1.15 | 20 | 40 | 40 | Chemical | 0.5 | Chemical | 2.0 | 1:4 |
| ment 3 | | | | | Formula | | Formula | | |
| | | | | | 1-1-A | | 2-1 | | |
| Embodi- | 1.15 | 20 | 40 | 40 | Chemical | 0.5 | Chemical | 2.0 | 1:4 |
| ment 4 | | | | | Formula | | Formula | | |
| | | | | | 1-1-A | | 2-3 | | |
| Embodi- | 1.15 | 20 | 40 | 40 | Chemical | 0.5 | Chemical | 2.0 | 1:4 |
| ment 5 | | | | | Formula | | Formula | | |
| | | | | | 1-2-A | | 2-1 | | |
| Embodi- | 1.15 | 20 | 40 | 40 | Chemical | 0.5 | Chemical | 2.0 | 1:4 |
| ment 6 | | | | | Formula | | Formula | | |
| | | | | | 1-2-A | | 2-3 | | |
| Embodi- | 1.15 | 20 | 40 | 40 | Chemical | 0.1 | Chemical | 10.0 | 1:100 |
| ment 7 | | | | | Formula | | Formula | | |
| | | | | | 1-1-B | | 2-1 | | |
| Embodi- | 1.15 | 20 | 40 | 40 | Chemical | 0.1 | Chemical | 10.0 | 1:100 |
| ment 8 | | | | | Formula | | Formula | | |
| | | | | | 1-1-B | | 2-3 | | |
| Embodi- | 1.15 | 20 | 40 | 40 | Chemical | 0.1 | Chemical | 10.0 | 1:100 |
| ment 9 | | | | | Formula | | Formula | | |
| | | | | | 1-1-A | | 2-1 | | |
| Embodi- | 1.15 | 20 | 40 | 40 | Chemical | 0.1 | Chemical | 10.0 | 1:100 |
| ment 10 | | | | | Formula | | Formula | | |
| | | | | | 1-1-A | | 2-3 | | |
| Embodi- | 1.15 | 20 | 40 | 40 | Chemical | 0.1 | Chemical | 10.0 | 1:100 |
| ment 11 | | | | | Formula | | Formula | | |
| | | | | | 1-2-A | | 2-1 | | |
| Embodi- | 1.15 | 20 | 40 | 40 | Chemical | 0.1 | Chemical | 10.0 | 1:100 |
| ment 12 | | | | | Formula | | Formula | | |
| | | | | | 1-2-A | | 2-3 | | |
| Embodi- | 1.15 | 20 | 40 | 40 | Chemical | 0.5 | Chemical | 0.5 | 1:1 |
| ment 13 | | | | | Formula | | Formula | | |
| | | | | | 1-1-B | | 2-1 | | |
| Embodi- | 1.15 | 20 | 40 | 40 | Chemical | 0.5 | Chemical | 0.5 | 1:1 |
| ment 14 | | | | | Formula | | Formula | | |
| | | | | | 1-1-B | | 2-3 | | |
| Embodi- | 1.15 | 20 | 40 | 40 | Chemical | 0.5 | Chemical | 0.5 | 1:1 |
| ment 15 | | | | | Formula | | Formula | | |
| | | | | | 1-1-A | | 2-1 | | |
| Embodi- | 1.15 | 20 | 40 | 40 | Chemical | 0.5 | Chemical | 0.5 | 1:1 |
| ment 16 | | | | | Formula | | Formula | | |
| | | | | | 1-1-A | | 2-3 | | |
| Embodi- | 1.15 | 20 | 40 | 40 | Chemical | 0.5 | Chemical | 0.5 | 1:1 |
| ment 17 | | | | | Formula | | Formula | | |
| | | | | | 1-2-A | | 2-1 | | |
| Embodi- | 1.15 | 20 | 40 | 40 | Chemical | 0.5 | Chemical | 0.5 | 1:1 |
| ment 18 | | | | | Formula | | Formula | | |
| | | | | | 1-2-A | | 2-3 | | |

For reference, in Table 1, a molarity (M) of the lithium salt may refer to a quantity (in mol) of the lithium salt dissolved in 1 liter (L) of the electrolyte, a volume ratio of the non-aqueous (e.g., water-insoluble) organic solvent may refer to a volume ratio of EC:EMC:DMC, and an amount of the additive may refer to a weight of the additive relative to the total 100 wt % (e.g., based on 100 wt % of a total amount) of the electrolyte.

### (2) Fabrication of Rechargeable Lithium Battery

LiCoO₂ as a positive electrode active material, polyvinylidene fluoride as a binder, and acetylene black as a conductive (e.g., electrically conductive) material were mixed in a weight ratio of 96:3:1, and the mixture was distributed in N-methyl pyrrolidone to prepare a positive electrode active material slurry.

The positive electrode active material slurry was coated on an Al foil of 15 μm in thickness, dried at 100° C., and then pressed to manufacture a positive electrode.

Artificial graphite and silicon nano-particles mixed in a weight ratio of 93:7 as a negative electrode active material, a styrene-butadiene rubber (SBR) as a binder, and carboxymethyl cellulose (CMC) as a thickener were mixed in a weight ratio of 98:1:1, and the mixture was distributed in distilled water to prepare a negative electrode active material slurry.

The negative electrode active material slurry was coated on a Cu foil of 10 μm in thickness, dried at 100° C., and then pressed to manufacture a negative electrode.

The positive electrode, the negative electrode, and a polyethylene separator of 10 μm in thickness were assembled to manufacture an electrode assembly, and the electrolyte was introduced to fabricate a rechargeable lithium battery.

### Evaluation

The rechargeable lithium batteries were evaluated by the following methods.

### Evaluation 1: Penetration

The following methods were used to evaluate penetration characteristics of the rechargeable lithium batteries according to Embodiments 1 to 18 and Comparatives 1 to 6.

The penetration evaluation was performed such that a fully charged (SOC100) rechargeable lithium cell was penetrated with a 1.0 phi (Φ) nail at 0.5 mm/s under room temperature (25° C.) and high temperature (60° C.) to record whether ignition occurred, and the results are listed in Table 2.

### Evaluation 2: Thermal Exposure

The rechargeable lithium batteries fabricated in Embodiments and Comparatives were exposed to high temperatures (130° C.) for 30 minutes, and then the occurrence of ignition was evaluated. The results are listed in Table 2.

The rechargeable lithium batteries fabricated in Embodiments and Comparatives were heated at a heating rate of 5° C. per minute under a high-temperature environment (130° C.) until the temperature reached 200° C., and an ignition point was identified. The results are listed in Table 2.

TABLE 2

| | | | Thermal exposure | |
|---|---|---|---|---|
| | | | (130° C., 30 min maintained | |
| | | | → 200° C. heating) | |
| | Penetration | | Ignition at | |
| | (1ØSUS nail, 0.1 mm/s) | | high- | |
| | Room | High | temperature | Ignition |
| | temperature | temperature | exposure | temperature |
| | (25° C.) | (60° C.) | (130° C.) | (° C.) |
| Comparative | Ignition | Ignition | Ignition | — |
| 1 | | | | |
| Comparative | No ignition | No ignition | Ignition | — |
| 2 | | | | |
| Comparative | No ignition | No ignition | Ignition | — |
| 3 | | | | |
| Comparative | No ignition | No ignition | Ignition | — |
| 4 | | | | |
| Comparative | Ignition | Ignition | No ignition | 135 |
| 5 | | | | |
| Comparative | Ignition | Ignition | No ignition | 135 |
| 6 | | | | |
| Embodiment | No ignition | No ignition | No ignition | 145 |
| 1 | | | | |
| Embodiment | No ignition | No ignition | No ignition | 145 |
| 2 | | | | |
| Embodiment | No ignition | No ignition | No ignition | 145 |
| 3 | | | | |
| Embodiment | No ignition | No ignition | No ignition | 145 |
| 4 | | | | |
| Embodiment | No ignition | No ignition | No ignition | 145 |
| 5 | | | | |
| Embodiment | No ignition | No ignition | No ignition | 145 |
| 6 | | | | |
| Embodiment | No ignition | Ignition | No ignition | 155 |
| 7 | | | | |
| Embodiment | No ignition | Ignition | No ignition | 155 |
| 8 | | | | |
| Embodiment | No ignition | Ignition | No ignition | 155 |
| 9 | | | | |
| Embodiment | No ignition | Ignition | No ignition | 155 |
| 10 | | | | |
| Embodiment | No ignition | Ignition | No ignition | 155 |
| 11 | | | | |
| Embodiment | No ignition | Ignition | No ignition | 155 |
| 12 | | | | |
| Embodiment | No ignition | No ignition | No ignition | 140 |
| 13 | | | | |
| Embodiment | No ignition | No ignition | No ignition | 140 |
| 14 | | | | |
| Embodiment | No ignition | No ignition | No ignition | 140 |
| 15 | | | | |
| Embodiment | No ignition | No ignition | No ignition | 140 |
| 16 | | | | |
| Embodiment | No ignition | No ignition | No ignition | 140 |
| 17 | | | | |
| Embodiment | No ignition | No ignition | No ignition | 140 |
| 18 | | | | |

### Evaluation 3: Charge/Discharge Cycle Characteristics at High Temperature (45° C.)

The rechargeable lithium batteries according to Embodiments and Comparatives were allowed to evaluate charge/discharge characteristics at high temperature. Each of the rechargeable lithium batteries was charged and discharged at 45° C. for 200 cycles under the condition of 0.33 C charge (CC/CV, 4.25 V, 0.05 C cut-off) and 0.5 C discharge (CC, 2.8 V cut-off).

A high-temperature capacity retention rate was calculated according to Equation 1. The results are listed in Table 3.

$$High - temperature capacity retention rate ( \% ) = ( discharge capacity after 200 cycles \text{} / discharge capacity after 1 cycle ) \times 100 \qquad Equation 1$$

TABLE 3

| | 45° C., 200 cycles |
|---|---|
| | High-temperature capacity retention |
| | rate (%) |
| Embodiment | 84.9 |
| 1 | |
| Embodiment | 83.6 |
| 7 | |
| Embodiment | 86.1 |
| 13 | |
| Comparative | 81.2 |
| 1 | |
| Comparative | 82.5 |
| 2 | |
| Comparative | 81.9 |
| 5 | |

### Comprehensive Evaluation

Referring to Table 2, it may be ascertained that, compared to Comparatives, there was an improvement in penetration stability and thermal safety (e.g., thermal runway) in Embodiments, each of which used the electrolyte added with the first additive and the second additive according to one or more embodiments of the present disclosure.

Referring to Table 3, it may be ascertained that, compared to Comparatives, there was an improvement in capacity retention rate in accordance with charge/discharge cycles at high temperatures in Embodiments, each of which used the electrolyte according to one or more embodiments of the present disclosure.

In an electrolyte according to one or more embodiments, a cesium salt compound and a phosphazene compound may be used in combination as an additive (additives), and thus there may be an effect of improving or enhancing stability (e.g., chemical stability and/or physical stability) and lifespan characteristics under a high-temperature condition if (e.g., when) a rechargeable lithium battery is activated. For example, in an electrolyte according to one or more embodiments, a cesium salt compound and a phosphazene compound may be used in combination as additives. This combination may improve or enhance stability (e.g., chemical stability and/or physical stability) and lifespan characteristics under high-temperature conditions if (e.g., when) a rechargeable lithium battery is activated.

A battery manufacturing device, a battery management system (BMS) device, and/or any other relevant devices or components according to one or more embodiments of the present disclosure may be implemented by utilizing any suitable hardware, firmware (e.g., an application-specific integrated circuit), software, and/or a (e.g., any suitable) combination of software, firmware, and hardware. For example, one or more suitable components of the device may be provided on one integrated circuit (IC) chip or on separate IC chips. Further, one or more suitable components of the device may be implemented on a flexible printed circuit film, a tape carrier package (TCP), a printed circuit board (PCB), and/or provided on one substrate. Further, the one or more suitable components of the device may be a process or thread, running on one or more processors, in one or more computing devices, executing computer program instructions and interacting with other system components to perform the one or more suitable functionalities described herein. The computer program instructions may be stored in a memory which may be implemented in a computing device using a standard memory device, such as, for example, a random access memory (RAM). The computer program instructions may also be stored in other non-transitory computer readable media, such as, for example, a CD-ROM, a flash drive, and/or the like. Also, a person of skill in the art should recognize that the functionality of one or more suitable computing devices may be combined or integrated into a single computing device, or the functionality of a particular computing device may be distributed across one or more other computing devices without departing from the scope of the present disclosure.

A person of ordinary skill in the art, in view of the present disclosure in its entirety, would appreciate that each suitable feature of the one or more embodiments of the present disclosure may be combined or combined with each other, partially or entirely, and may be technically interlocked and operated in one or more suitable ways, and each embodiment may be implemented independently of each other or in conjunction with each other in any suitable manner unless otherwise stated or implied.

While the subject matter of the present disclosure has been described in connection with what is presently considered to be practical embodiments, it is to be understood that the present disclosure is not limited to the disclosed embodiments. In contrast, it is intended to cover one or more suitable modifications and equivalent arrangements included within the spirit and scope of the appended claims and equivalents thereof. It therefore will be understood that one or more embodiments described above are just illustrative but not limitative in all aspects.

What is claimed is:

1. An electrolyte, comprising:
a non-aqueous organic solvent;
a lithium salt;
a first additive that comprises a cesium salt compound represented by Chemical Formula 1-1 or Chemical Formula 1-2; and
a second additive that comprises a phosphazene compound represented by Chemical Formula 2, 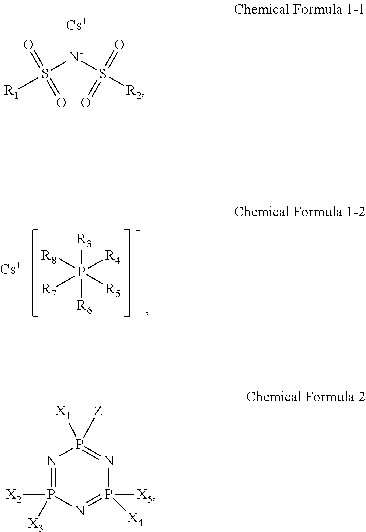
wherein, in Chemical Formula 1-1 or Chemical Formula 1-2,
R₁ to R₈ are each independently a fluoro group or a C1 to C4 fluoroalkyl group substituted with at least one fluoro group,
wherein, in Chemical Formula 2,
X₁ to X₅ are each independently a halogen atom or a halogen-containing group, and
Z is —NR₉R₁₀ or —OR₁₁,
wherein R₉ and R₁₀ are each independently a substituted or unsubstituted C1 to C30 alkyl group or a substituted or unsubstituted C1 to C30 cycloalkyl group,
wherein R₁₁ is a substituted or unsubstituted C1 to C30 alkyl group, and
wherein the electrolyte is an electrolyte for a rechargeable lithium battery.

2. The electrolyte as claimed in claim 1, wherein Chemical Formula 1-1 is represented by Chemical Formula 1-1-A or Chemical Formula 1-1-B,

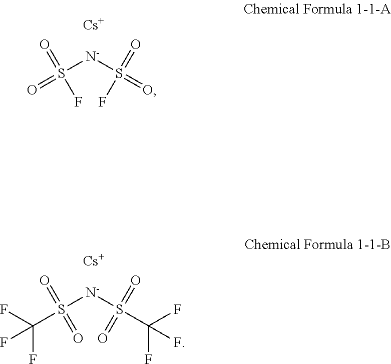

3. The electrolyte as claimed in claim 1, wherein Chemical Formula 1-2 is represented by Chemical Formula 1-2-A,

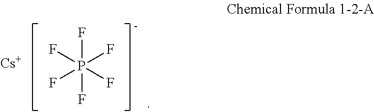

4. The electrolyte as claimed in claim 1, wherein at least one selected from among X₁ to X₅ in Chemical Formula 2 is a halogen atom.

5. The electrolyte as claimed in claim 1, wherein at least one selected from among X₁ to X₅ in Chemical Formula 2 is fluorine.

6. The electrolyte as claimed in claim 1, wherein Chemical Formula 2 comprises at least one selected from among compounds represented by Chemical Formula 2-1, Chemical Formula 2-2, and Chemical Formula 2-3,

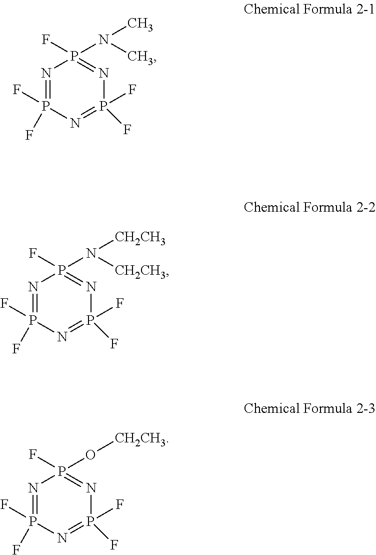 [SMILES: CN(C)P1(F)=NP(F)(F)=NP(F)(F)=N1 ; CCN(CC)P1(F)=NP(F)(F)=NP(F)(F)=N1 ; CCOP1(F)=NP(F)(F)=NP(F)(F)=N1]

7. The electrolyte as claimed in claim 1, wherein the first additive is in an amount of about 0.01 wt % to about 5 wt % based on 100 wt % of a total amount of the electrolyte.

8. The electrolyte as claimed in claim 1, wherein the second additive is in an amount of about 0.01 wt % to about 10 wt % based on 100 wt % of a total amount of the electrolyte.

9. The electrolyte as claimed in claim 1, wherein the first additive and the second additive are in a weight ratio of about 1:1 to about 1:100.

10. The electrolyte as claimed in claim 1, wherein the first additive and the second additive are in a weight ratio of about 1:1 to about 1:10.

11. The electrolyte as claimed in claim 1, wherein the non-aqueous organic solvent comprises at least one selected from among ethyl methyl carbonate (EMC), ethylene carbonate (EC), dimethyl carbonate (DMC), propylene carbonate (PC), propyl propionate (PP), diethyl carbonate (DEC), dipropyl carbonate (DPC), methylpropyl carbonate (MPC), ethylpropyl carbonate (EPC), methylethyl carbonate (MEC), and butylene carbonate (BC).

12. The electrolyte as claimed in claim 1, wherein the lithium salt comprises at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), and LiC₄F₉SO₃.

13. The electrolyte as claimed in claim 1, wherein the lithium salt comprises at least one selected from among lithium tetrafluoro (oxalato)phosphate (LiTFOP), lithium difluoro bis(oxalato)phosphate (LiDFOP), lithium difluoro oxalato borate (LiDFOB), and lithium bis(oxalato) borate (LiBOB).

14. The electrolyte as claimed in claim 1, wherein a concentration of the lithium salt is in a range of about 0.1 M to about 2.0 M.

15. A rechargeable lithium battery, comprising:
a positive electrode that comprises a positive electrode active material;
a negative electrode that comprises a negative electrode active material; and
the electrolyte as claimed in claim 1.

16. The rechargeable lithium battery as claimed in claim 15, wherein the positive electrode active material comprises lithium composite oxide represented by Chemical Formula 3, 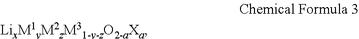
and
wherein, in Chemical Formula 3,
$$0.5 \leq x \leq 1.8 , 0 \leq a \leq 0.05 , 0 < y \leq 1 , 0 \leq z \leq 1 , and 0 \leq y + z \leq 1.$$
M¹, M², and M³ each independently comprise at least one element selected from among metals of Ni, Co, Mn, Al, B, Ba, Ca, Ce, Cr, Fe, Mo, Nb, Si, Sr, Mg, Ti, V, W, Zr, La, and a combination thereof, and
X comprises at least one element selected from among F, S, P, and Cl.

17. The rechargeable lithium battery as claimed in claim 16, wherein, in Chemical Formula 3, M¹ is Ni, y is 0.8≤y≤1, and z is 0≤z≤0.2.

18. The rechargeable lithium battery as claimed in claim 15, wherein the negative electrode active material comprises at least one selected from among graphite and a silicon composite.

19. The rechargeable lithium battery as claimed in claim 15, wherein the rechargeable lithium battery is a cylindrical battery, a prismatic battery, a pouch-type battery, or a coin-type battery.
